(19) United States
(12) Patent Application Publication
(10) Pub. No.: US 2026/0286867 A1
(43) Pub. Date: Sep. 24, 2026

(54) APPARATUS FOR THERMAL ENERGY STORAGE AND PLANT FOR ENERGY TRANSFORMATION AND STORAGE

(71) Applicant: ENERGY DOME S.P.A., Milano (IT)

(72) Inventors: Claudio SPADACINI, Milano (IT); Dario RIZZI, Milano (IT)

(73) Assignee: ENERGY DOME S.P.A., Milano (IT)

(21) Appl. No.: 19/100,632

(22) PCT Filed: Jul. 31, 2023
(86) PCT No.: PCT/IB2023/057748

§ 371 Date: Feb. 3, 2025

(30) Foreign Application Priority Data
Aug. 3, 2022 (IT) 102022000016569

(51) Int. Cl. F01K 3/26; F28D 20/00

(52) U.S. Cl. CPC F01K 3/262; F28D 20/0034; F28D 2020/0078; F28D 2020/0082

(57) ABSTRACT

An apparatus for thermal energy storage includes a basin containing a thermal mass having a liquid and configured to absorb or release heat and a main heat exchanger contained in the basin and immersed in the thermal mass. Main ducts connect the main heat exchanger with a first source of a working fluid in the gaseous state or with a second source of the working fluid in the liquid state. A boiling temperature of the liquid of the thermal mass is greater than a condensing/evaporating temperature of the working fluid. The apparatus can be in a condensing operating configuration, in which the working fluid in the gaseous state flows from the first source through the main heat exchanger, releases heat to the thermal mass and condenses, or in an evaporating operating configuration, absorbs heat from the thermal mass and evaporates.

### FIELD OF THE FINDING

The present invention has as its object an apparatus for thermal energy storage and a plant for energy transformation and storage.

More precisely, the present invention has as its object an apparatus able to accumulate thermal energy released by a working fluid in a thermal mass contained in a basin of wide dimensions wherein it is immersed a heat exchanger within which the aforementioned working fluid flows. The apparatus according to the invention is able to condense or evaporate the working fluid by using the exchange of thermal energy with the thermal mass of the basin.

### BACKGROUND OF THE FINDING

In the field of thermal energy storage systems, it is known the use of heat exchangers configured to transfer heat between two fluids. This heat is then, for example, accumulated in one of the two fluids or in a different thermal mass in contact with one of the two fluids.

There are known heat exchangers that are able to exchange their thermal content by keeping the two fluids separated. These exchangers are provided with a geometric construction such as to prevent a mixture between the two fluids, i.e. each of the two fluids is confined within a respective closed volume.

For example, in the plate heat exchangers, two fluid flows at different temperature exchange their thermal content through embossed surfaces and arranged next to each other where fluids flow in counterflow.

The known heat exchanger of “shell & tube” type (tube bundle and shell) is a surface heat exchanger mainly constituted by a bundle of tubes placed within a container of substantially cylindrical shape (denominated shell). This exchanger is crossed by two fluid flows: a flow flows on the “tubes side” (i.e. within the tubes), whereas the other flow flows on the “shell side” (i.e. in the space delimited between the internal surface of the shell and the external surfaces of tubes). For example, while it flows in the heat exchanger, one of the two fluids exchanges latent heat (condensing or evaporating) and the other fluid exchanges sensitive heat (heating up or cooling down).

### SUMMARY

In this field, the Applicant has noted that, in order to make efficient a heat exchanger that shall carry out a condensation or an evaporation according to the known art, i.e. for example of plate or “shell & tube” type, it is necessary to increase the thermal exchange surfaces or to increase the flow rate of the fluid that heats up or cools down through the condensation or the evaporation of the other fluid.

The Applicant has noted that the increase of the surfaces within certain limits is not convenient since it becomes uneconomical. The Applicant has furthermore noted that the increase of the flow rates involves an increase of pressure drops in the pipes and then the need to adopt pumps, configured to work on the fluid that heats up or cools down, more powerful and expensive and/or the need to increase the dimensions of pipes and/or of the exchanger with consequent increase of costs and generation of disturbances related to the greater heat exchange of the increased pipes with the surrounding environment (if the fluid that heats up or cools down is at a temperature other than the environmental temperature).

The Applicant has furthermore noted that, if the exchanger is used in the field of apparatuses for thermal energy storage destined then in a second step to be released for example for generating electrical energy, the use of powerful pumps involves the generation of a considerable amount of heat by the motors of the pumps themselves which disturbs the exchange of thermal energy between the two fluids.

In fact, the additional heat generated by the pumps is accumulated too and is an extra quantity that shall be extracted in the step of electrical energy generation and negatively affects the efficiency of the system.

The Applicant has then set itself as purpose to realize an apparatus for thermal energy storage able to overcome the above shown technical drawbacks.

In particular, the Applicant has set itself as purpose to realize an apparatus for thermal energy storage:
structurally simpler than those known;
able to work efficiently with reduced powers and reduced self-consumptions;
substantially free of disturbances due to heat exchanges with the surrounding environment and heat generated by fluid handling systems (such as pumps).

The Applicant has found that the above indicated objectives and other ones can be reached through an apparatus for thermal energy storage according to the attached claims and/or according to one or more of the following aspects.

In a first independent aspect, the present invention refers to an apparatus for thermal energy storage, comprising:
a thermal mass comprising a liquid, optionally water, wherein the thermal mass is configured to absorb and store heat or to release heat;
a basin containing the thermal mass;
at least one main heat exchanger contained in the basin and immersed in the thermal mass; wherein the liquid is movable in the basin and with respect to said at least one main heat exchanger;
main ducts connecting said at least one main heat exchanger with a first source of a working fluid in the gaseous state or with a second source of the same working fluid in the liquid state;
wherein a boiling temperature of the liquid of the thermal mass is greater than a condensing/evaporating temperature of the working fluid, optionally greater than the critical temperature of the working fluid;
devices for configuring the apparatus in a condensing operating configuration, in which the working fluid in the gaseous state flows from the first source through said at least one main heat exchanger, releases heat to the thermal mass and condenses while the thermal mass heats up, or in a evaporating operating configuration, in which the working fluid in the liquid state flows from the second source through said at least one main heat exchanger, absorbs heat from the thermal mass and evaporates while the thermal mass cools down;
wherein a ratio of a volume of the basin to an internal volume of said at least one main heat exchanger is greater than one hundred.

As internal volume of the main exchanger it is intended the internally delimited volume in the main exchanger and in which it is present and flows the working fluid.

As main exchanger it is intended that element opportunely designed to exchange heat with the thermal mass in the basin excluding ducts connecting that element with the first source of the working fluid in the gaseous state and/or with the second source of the same working fluid in the liquid state and which are also possibly partly housed in the basin.

The Applicant has first of all verified that the apparatus according to the invention allows to receive in inlet, from a first system, the working fluid in the gaseous state and to make it available to a second storage system in liquid phase. The Applicant has verified that the apparatus according to the invention allows to, subsequently, receive from the second system the fluid in the liquid state and return it to the first system in gaseous phase and under conditions similar to those when the apparatus has received it. The working fluid in the main heat exchanger exchanges heat with the thermal mass for obtaining these phase transformations (latent heat) while the thermal mass heats up or cools down (sensitive heat).

The Applicant has first of all verified that the solution according to the invention allows first to accumulate and then to release the thermal energy in an efficient manner.

The Applicant has verified that the solution according to the invention allows to drastically limit the pressure drops due to the movement of the liquid of the thermal mass, since the invention does not use pipes or passing lights for the liquid of the thermal mass or uses a very limited number of them, being the liquid of the thermal mass contained in the basin and moving substantially only in said basin.

Furthermore, the dimension of the basin with respect to the one of the main heat exchanger is such as to contain pressure drops due to the movement of the liquid in the basin, as opposed to what occurs for example in the exchangers of “shell & tube” type.

The Applicant has also verified that the structure of the apparatus according to the invention is relatively simple and therefore cost-effective, since the aforementioned pipes (with the relative and necessary insulation) and/or lights are not required to convey the liquid from the thermal mass.

The Applicant has furthermore verified that the substantial absence of pipes allows to reduce the disturbances related to the heat exchange with the surrounding environment: all the heat directly or indirectly exchanged goes/arrives in/from the thermal mass. Further aspects of the invention are described below.

In an aspect, the apparatus for thermal energy storage comprises the working fluid.

In an aspect, the apparatus for thermal energy storage comprises the first source of the working fluid in the gaseous state and/or the second source of the same working fluid in the liquid state.

In an aspect, the ratio of the volume of the basin to the internal volume of the main heat exchanger is greater than three hundred, optionally greater than five hundred.

In an aspect, the working fluid has a critical temperature close to environment temperature, optionally comprised between 0° C. and 100° C.

In an aspect, the working fluid is chosen in the group comprising: carbon dioxide CO₂, sulphur hexafluoride SF₆, nitrogen oxide N₂O, hydrocarbons, perfluorinated compounds, water.

In an aspect, the working fluid is a mixture.

In an aspect, the working fluid is air.

In an aspect, the thermal mass is a liquid.

In an aspect, the liquid is water or comprises water.

In an aspect, the thermal mass comprises oils or hydrocarbons, for example propane.

In an aspect, the thermal mass is a mixture comprising said liquid and at least an additive, for example salt.

In an aspect, the thermal mass comprises said liquid and solid particles or bodies, for example ice, sand, gravel.

In an aspect, the basin is natural, for example a river, a lake, a sea.

In an aspect, the basin is artificial, i.e. the basin is man-made, for example a tank, an artificial lake delimited by a dam or a swimming pool.

In an aspect, the basin is underground.

In an aspect, the basin comprises lateral walls of concrete or metal.

In an aspect, a surface of the liquid in the basin is in contact with the atmosphere or in contact with a controlled atmosphere, for example comprising nitrogen.

In an aspect, a surface of the liquid in the basin is at atmospheric pressure or at a pressure slightly greater than atmospheric pressure, for example at a pressure of a few mbar up to a few hundred mbar.

In an aspect, the basin can have any geometry, for example the basin has, in plain view, a rectangular, square or circular perimeter.

In an aspect, the basin is insulated to limit heat exchanges with the external environment.

In an aspect, the liquid is naturally movable in the basin (for example due to natural flows present in a river, lake or sea) or by forced circulation.

In an aspect, the basin delimits a closed volume, i.e. the liquid in the basin is substantially always the same. The mentioned closed volume is to be considered closed if there is no substantial mass exchange of the thermal mass between the limits of this volume and the surrounding environment, open if there is a possibility of mass exchange.

In this case, the thermal mass accumulates and stores the heat removed from the working fluid in the condensing operating configuration in order to then return this heat to the working fluid in the evaporating operating configuration.

In an aspect, at least a circulation device is operatively active on the liquid and is configured to move said liquid in the basin and with respect to said at least one main heat exchanger.

In an aspect, said at least one circulation device comprises a propeller or a pump, for example, axial pumps or lifting pumps or any means for overcoming the small pressure drops that occur in the basin, also due to the presence of the main heat exchanger.

In an aspect, said at least one circulation device is present if the volume is closed and, preferably but not necessarily, if the basin is artificial.

In an aspect, said at least one circulation device is configured to generate within the closed volume at least one closed liquid circulation path.

In an aspect, said at least one circulation device is placed in the basin and is immersed in the liquid of the basin. The placing of the circulation device in the basin allows to avoid the use of any connecting pipe between the circulation device and the basin and thus to further limit pressure drops.

In an alternative aspect, said at least one circulation device is placed out of the basin and is in fluid communication with the basin through a pipe. In this case, the most important pressure drops are only localized in this pipe.

The Applicant has then verified that it is possible to use circulation devices with low powers and contained cost and thus to limit the heat disturbance deriving from the motors of such circulation devices during their operation.

In an aspect, a first liquid transit section in the basin is an area orthogonal to a direction of a flow of the liquid, a second transit section of the working fluid in said at least one main heat exchanger is an area orthogonal to a direction of a flow of the working fluid in the main heat exchanger.

In an aspect, the first transit section is a section of said at least one closed liquid circulation path.

In an aspect, a ratio of the first transit section to the second transit section is greater than one hundred, optionally greater than five hundred.

In an aspect, the first transit section is greater than 10 m², optionally greater than 20 m², optionally greater than 100 m².

In an aspect, the second transit section is comprised between 0.2 m² and 2 m².

In an aspect, the volume of the basin is greater than 1000 m³, optionally greater than 2000 m³, optionally greater than 10000 m².

In an aspect, a transit velocity of the liquid through the first transit section is lower than 10 m/s, optionally lower than 1 m/s.

In an aspect, a transit velocity of the liquid through the first transit section is greater than 0.01 m/s, optionally greater than 0.05 m/s.

In an aspect, a transit velocity of the liquid through the second transit section is lower than 1 m/s, optionally lower than 0.5 m/s.

In an aspect, a transit velocity of the liquid through the second transit section is greater than 0.01 m/s, optionally greater than 0.05 m/s.

In an aspect, at least one conveyor and/or at least one flow diverter is housed in the basin and immersed in the liquid of the basin. The function of the conveyor and/or of the flow diverter is to allow all the liquid of the basin to circulate and/or to exchange heat with the heat exchanger. In this way, all the liquid laps the main heat exchanger or otherwise participates in the heat exchange and energy storage.

In an aspect, said at least one conveyor comprises a cylindrical or hood-shaped body with open opposite ends.

In an aspect, said at least one main heat exchanger is placed within the conveyor or at a first open end of the conveyor.

In an aspect, said at least one circulation device is placed within the conveyor or at a second open end of the conveyor.

In an aspect, said at least one flow diverter comprises one or more walls, optionally connected to lateral walls delimiting the basin.

In an aspect, the walls of said at least one flow diverter are shaped and/or arranged to give the liquid a serpentine trajectory along the closed circulation path.

In an aspect, said at least one main heat exchanger delimits internally at least a passage for the working fluid, optionally a plurality of passages.

In an aspect, said at least one main heat exchanger delimits externally one or more passages for the liquid wherein said at least one main heat exchanger is immersed.

In an aspect, said at least one main heat exchanger is of the “once through” type.

In a “once through” type exchanger there are no accumulations of the working fluid, i.e. what goes in is equal to what comes out. The “once through” heat exchanger allows to condense and evaporate working fluids constituted by gas mixtures (as for example air but also carbon dioxide, which may not be pure at the 100%) without the individual components separating.

In an aspect, said at least one main heat exchanger comprises at least one bundle of tubes, the liquid passing between the tubes and lapping said tubes and the working fluid passing in said tubes. The working fluid, condenses or evaporates within said tubes.

In an aspect, a flow of the liquid in the basin is orthogonal with respect to said tubes.

In an aspect, the second transit section of the working fluid is the sum of the sections of the tubes.

In an aspect, said at least one main heat exchanger acts as condenser in the condensing operating configuration and acts as evaporator in the evaporating operating configuration.

In an aspect, said at least one main heat exchanger comprises a circulation circuit with a direct-contact condenser and a circulation pump.

In an aspect, said at least one main heat exchanger comprises: a first main heat exchanger and a second main heat exchanger.

In an aspect, the first main heat exchanger acts as condenser in the condensing operating configuration and the second main heat exchanger acts as evaporator in the evaporating operating configuration.

In an aspect, each one between said at least one main heat exchanger, the first main heat exchanger and the second main heat exchanger may be formed by a plurality of exchangers working in series or in parallel.

In an aspect, at least a reservoir, optionally a plurality of tanks, is/are in fluid connection with said at least one main heat exchanger. The reservoir or the reservoirs is/are configured to receive and accumulate the condensed working fluid deriving from said at least one main heat exchanger.

In an aspect, the reservoirs of the plurality of reservoirs are connected in parallel and/or in series among them.

In an aspect, said at least one reservoir is placed within the basin and is at least partially immersed in the liquid of the basin, preferably totally immersed in the liquid of the basin. In this way, said at least one reservoir is protected in the basin, does not occupy additional space and any undesired and uncontrolled heat exchanges occur with the thermal mass in which the reservoir is immersed and not with the external environment.

In an aspect, in the condensing operating configuration, the second source acts as said at least one reservoir that receives and accumulates the condensed working fluid.

In an aspect, in the evaporating operating configuration, the first source comprises a container for the working fluid evaporated in the gaseous state.

In an aspect, said at least one main heat exchanger has a first end in fluid connection with the first source or with the container and a second end in fluid connection with the second source or with said at least one reservoir.

In an aspect, the apparatus comprises the first source or the container.

In an aspect, the apparatus comprises the second source or said at least one reservoir.

In an aspect, at least one liquid-vapour separator is coupled to said at least one main heat exchanger. The liquid-vapour separator separates a liquid phase of the working fluid in the gaseous state that enters in or comes out of the main heat exchanger.

In an aspect, said at least one liquid-vapour separator is in fluid communication, on one side, with the first end of said at least one passage for the fluid and, on an opposite side, with the first source or with the container. The liquid-vapour separator is therefore placed at the condenser inlet or at the evaporator outlet.

In an aspect, said at least one liquid-vapour separator is placed within the basin and is at least partially, preferably totally, immersed in the liquid of the basin.

In an alternative aspect, said at least one liquid-vapour separator is outside of the basin.

In an aspect, the liquid-vapour separator is placed in an upper position with respect to said at least one reservoir.

In an aspect, the liquid-vapour separator is connected to said at least one reservoir via a respective pipeline, internal or external to the reservoir. In this way, a liquid state separated in the above liquid-vapour separator falls by gravity into the reservoir below.

In an aspect, the mentioned pipeline has a geometry such as to define a hydraulic guard, i.e. to ensure that all the vapour passes through the main heat exchanger, i.e. preventing that the vapour bypasses this main heat exchanger.

In an aspect, there is an auxiliary device comprising at least one auxiliary heat exchanger, optionally a plurality of auxiliary exchangers in parallel and/or in series among them.

In an aspect, said at least one auxiliary heat exchanger is in fluid communication, on one side, with the main heat exchanger or with the liquid-vapour separator and, on an opposite side, with the first source or with the container.

The auxiliary heat exchanger is placed upstream of said at least one main heat exchanger when the apparatus is in the condensing operating configuration, for de-superheating the working fluid. The auxiliary heat exchanger is placed downstream of said at least one main heat exchanger when the apparatus is in the evaporating configuration, for superheating the working fluid.

The apparatus of the invention is then able to, in a first step, condense and also de-superheat the working fluid and store it in liquid phase and, in a second step, to evaporate and also to superheat the working fluid in gaseous phase or vice versa.

In an aspect, said at least one auxiliary heat exchanger has passages for the working fluid and passages for a thermal vector configured to exchange heat with the working fluid.

In an aspect, the thermal vector is different from the thermal mass of the basin.

In an alternative aspect, the thermal vector is the same thermal mass contained in the basin.

In an aspect, said at least one auxiliary heat exchanger is in fluid communication with the basin so as to use the thermal mass or the liquid of the thermal mass of the basin to de-superheat or to superheat the working fluid.

In an aspect, the auxiliary device comprises at least one auxiliary reservoir for the accumulation of the thermal vector, wherein said at least one auxiliary reservoir is in fluid communication with said at least one auxiliary heat exchanger and, optionally, with the basin.

In an aspect, said at least one auxiliary reservoir is placed in the basin and is at least partially, preferably totally, immersed in the liquid of the basin.

In an alternative aspect, said at least one auxiliary reservoir is outside of the basin.

In an aspect, an auxiliary system is operatively coupled to the basin and is configured to exchange heat with the thermal mass in the basin, preferably if the basin is artificial. The auxiliary system is configured to allow the thermal mass in the basin to exchange heat with the surrounding environment or with an external process in a controlled manner.

In an aspect, the auxiliary system comprises a chiller (chiller) able to remove heat from the thermal mass and to release it to the surrounding environment or to the external process or a heater able to release heat to the thermal mass after having collected it from the surrounding environment or from the external process.

In an aspect, the auxiliary system is in fluid connection with the main ducts and is configured to exchange heat with the thermal mass in the basin via the working fluid.

The auxiliary system uses the working fluid itself to obtain the effect of introducing or extracting heat in the/from the thermal mass in a controlled manner.

In an aspect, the auxiliary system comprises: a compressor, an expander or a lamination valve, an additional heat exchanger interposed between the compressor and the expander or lamination valve, a motor-generator mechanically connected to the compressor and/or to the expander.

In an aspect, ducts connect the compressor, the additional heat exchanger, the expander or the lamination valve, said at least one main heat exchanger to form a closed circuit.

The auxiliary system allows, through the introduction of electrical energy, to perform a chiller cycle with the working fluid and to directly remove heat from the working fluid and, consequently, from the thermal mass contained in the basin. In this particular case, said at least one main exchanger is an integral part of the chiller cycle and performs the function of the evaporator, whereas the additional exchanger removes heat. The expander is in this case a tool capable of extracting energy from the working fluid and achieving a better cooling efficiency. In this case, the electrical machine introduces energy into the system.

In an aspect, a pumping station is placed between said at least one main heat exchanger and said at least one reservoir.

In an aspect, the plurality of reservoirs comprises a main reservoir directly connected to said at least one main heat exchanger and at least one storage reservoir connected to the main reservoir, optionally a plurality of storage reservoirs.

In an aspect, the storage reservoirs are connected in parallel and/or in series among them.

In an aspect, the pumping station is placed between the main reservoir and said at least one storage reservoir. The pumping station is configured to move the working fluid in liquid phase from the main reservoir to the storage reservoirs and vice versa.

In an aspect, the pumping station comprises valves and/or pumps that allow to move the fluid from one side to the other or vice versa by using the gravity and/or a pressure difference.

In an aspect, the respective pipeline connects the liquid-vapour separator to the main reservoir.

In an aspect, an additional basin containing the thermal mass is connected to the basin via an additional pipeline and a further heat exchanger is operatively active between the additional pipeline and the second pipeline in an area comprised between said at least one storage reservoir and the main heat exchanger, to exchange heat between the thermal mass and the working fluid.

In an aspect, the further heat exchanger is operatively active between the additional pipeline and the second pipeline in an area comprised between said at least one storage reservoir and the pumping station.

In an aspect, the further heat exchanger, in the condensing operating configuration, is configured to sub-cool the working fluid before the accumulation in said at least one storage reservoir until keeping a temperature Te of the working fluid in liquid phase at the end of condensation close to a temperature Ts of the working fluid in vapour phase at the beginning of condensation.

In an aspect, a temperature of the thermal mass in the additional basin is lower than the temperature Ts of carbon dioxide at the beginning of condensation.

In an aspect, an additional pump is operative on the additional pipeline, optionally between said at least one storage reservoir and the further heat exchanger.

In an aspect, the further heat exchanger is outside of the basin.

In an aspect, in the configuration of condensing operating configuration, the thermal mass in the additional basin is pumped toward the basin and passes in the further heat exchanger while the working fluid flows toward said at least one storage reservoir.

In an aspect, in the evaporating operating configuration, the working fluid is heated before evaporating it to bring it close to the evaporating temperature by following the reverse path, and then going back to cool down part of the thermal mass.

The Applicant has verified that the sub-cooling operated via the thermal mass in the additional basin and the further heat exchanger allows to substantially increase the density of the working fluid in the reservoirs and then to reduce the volume and/or the number of necessary reservoirs, their dimensions and the relative cost.

In an aspect, the main reservoir is inside the basin and said at least one storage reservoir is inside or outside of the basin. In this way, the main reservoir and the possible storage reservoir inside the basin are thermally insulated from the external environment via the thermal mass. This is useful for keeping any heat exchange with the working fluid within the thermal mass.

In an aspect, at least one steam balancing pipeline connects an upper portion of said at least one storage reservoir with a point of the main ducts placed between the first source and said at least one main heat exchanger or to the first end of said at least one main heat exchanger or to the liquid-vapour separator.

In an aspect, an adjustment valve is operatively active on said steam balancing pipeline.

The steam balancing pipeline and the adjustment valve are configured to “balance” the vapour phase of the working fluid contained in said at least one storage reservoir with the first end of said at least one main heat exchanger. This balancing is useful to free space for the liquid when it enters the reservoirs, otherwise there would be an increase in pressure due to the compression of the vapour phase.

In an aspect, it is provided a device configured to eliminate non-condensable gases.

In an aspect, the device configured to eliminate non-condensable gases is placed at an upper portion of the apparatus, where said incondensable gases can accumulate. This device can be connected at different points of the apparatus where the gaseous phase of the working fluid is present.

In an aspect, the device configured to eliminate non-condensable gases is operatively connected to the first end of said at least one main heat exchanger or to the liquid-vapour separator or to the steam balancing pipeline.

In an aspect, the devices for configuring the apparatus in the condensing operating configuration or in the evaporating operating configuration comprise: manual valves or actuated valves and a control unit operatively connected to the actuated valves and eventually to safety pumps and/or valves.

In an aspect, the devices for configuring the apparatus in the condensing operating configuration or in the evaporating operating configuration are operatively active on the main ducts and/or on said at least one main heat exchanger and/or on the first source or reservoir and/or on the second source or container.

The present invention is also related to a plant for energy transformation and storage, comprising the apparatus for thermal energy storage according to one or more of the preceding aspects.

In an aspect, the plant for energy transformation and storage comprises:
a working fluid other than atmospheric air;
an enclosure configured to store the working fluid in gaseous phase;
at least one compressor in fluid communication with the enclosure;
at least one expander in fluid communication with the enclosure;
an apparatus according to at least one of the preceding aspects, wherein the main ducts of the apparatus are in fluid communication with the compressor and with the expander.

In an aspect, the enclosure is in fluid communication with an inlet of the compressor or with an outlet of the expander and said apparatus is in fluid communication with an outlet of the compressor or with an inlet of the expander.

In an aspect, the apparatus is used in the plant as an accumulator of thermal energy generated during the compression in the compressor.

In an aspect, it is provided a primary heat exchanger operatively interposed between said apparatus and said compressor and expander, optionally said primary heat exchanger is a thermal accumulator (Thermal Energy Storage-TES) or is connected to a thermal accumulator.

In an aspect, the main heat exchanger of the apparatus is a secondary heat exchanger of the plant.

In an aspect, the plant is configured to actuate a closed cyclic thermodynamic transformation, first in one direction in an accumulation configuration and then in an opposed sense in a discharge configuration, between said enclosure and said at least a reservoir of the apparatus; wherein in the accumulation configuration the plant stores heat and pressure and in the discharge configuration generates energy.

In an aspect, the plant comprises: a floating unit carrying at least the enclosure, said at least one compressor and said at least one expander.

In an aspect, the basin is a river, a lake or a sea and said at least one reservoir and said at least one main heat exchanger are immersed in the river, lake or sea.

In the present description and in the attached claims reference will be made to the following definitions.
Thermodynamic cycle (CT): thermodynamic transformation from a point X to a point Y, wherein X coincides with Y; the CT unlike the TTC (Cyclic thermodynamic transformation) referred to below has no mass accumulations (significant for energy purposes) within the cycle, while the TTC typically works between two storages of working fluid, one initial and the other one final;
Cyclic thermodynamic transformation (TTC): thermodynamic transformation from a point X to a point Y and from a point Y to a point X, without necessarily passing through the same intermediate points;
Closed CT and/or TTC: without mass exchange (significant for energy purposes) with the atmosphere;
Open CT and/or TTC: with mass exchange (significant for energy purposes) with the atmosphere.

Further features and advantages will be clearer from the detailed description of preferred, but not exclusive embodiments of an apparatus for thermal energy storage and a plant for energy transformation and storage according to the present invention.

### DESCRIPTION OF FIGURES

This description will be shown below with reference to the attached drawings, provided for illustrative purposes only and, therefore, not limiting thereto, in which:

FIGS. 1A and 1B show an apparatus for thermal energy storage according to the present invention in respective operating configurations;

FIG. 2 shows a variant of the apparatus of FIGS. 1A and 1B; figures from 3A to 3D show the detail of a device of the apparatus of which in the preceding figures in respective operating steps;

FIGS. 4, 4A and 4B are T-S diagrams representing the transformations made by the apparatus according to the present invention;

figures from 5 to 8 show portions of respective variants of the apparatus for thermal energy storage according to the present invention;

FIG. 9 shows a plant for energy transformation and storage comprising another variant of the apparatus for thermal energy storage according to the present invention;

FIG. 10 shows an example of a heat exchanger used in the apparatus according to the invention;

FIG. 11 shows another variant of the apparatus of FIGS. 1A and 1B;

FIG. 12 shows a variant of the apparatus of FIG. 2;

FIG. 13 is a T-S diagram which represents a transformation operated by the apparatus of FIG. 12.

### DETAILED DESCRIPTION

With reference to the attached figures, with the reference number 1 it has been overall indicated an apparatus for thermal energy storage according to the present invention.

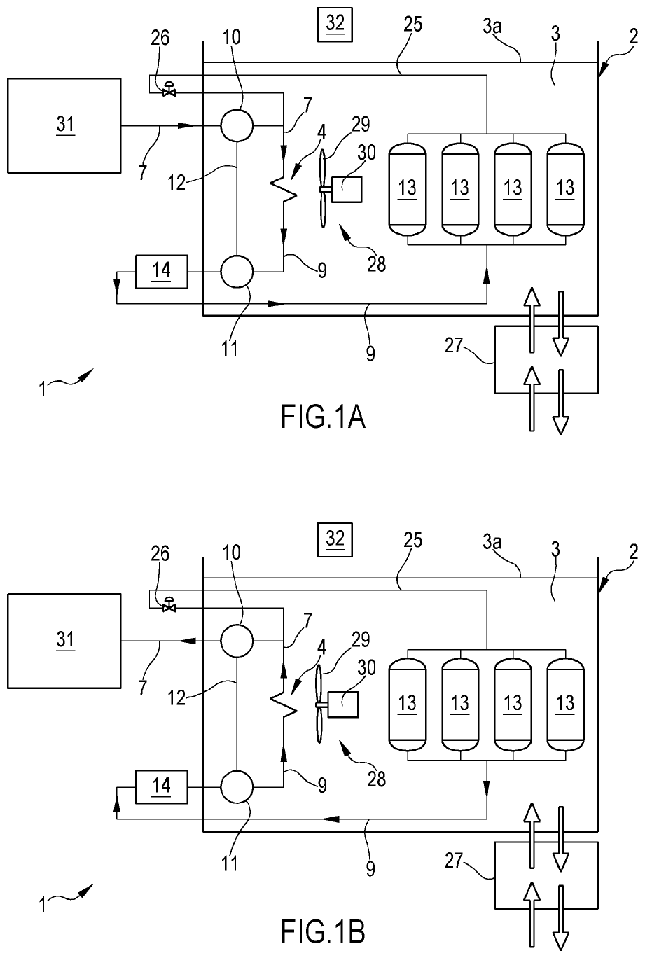

FIGS. 1A and 1B show a first embodiment of the apparatus 1 that comprises a basin 2 containing water 3. The basin 2 shown in this embodiment is of artificial type, i.e. is man-made for example with lateral walls and base in reinforced concrete, has a parallelepiped shape and dimensions such as to contain a volume of water equal to about 250 m³ or 250000 liters. A surface 3a of the water 3 in the basin 2 is in contact with the atmosphere.

In embodiment variants, instead of water can be used a mixture comprising water and an additive, for example salt, or water and solid particles or bodies, for example ice, sand, gravel. In embodiment variants, the thermal mass comprises oils or hydrocarbons, for example cryogenic propane. In embodiment variants, the basin 2 can be a metal tank, possibly insulated. In embodiment variants, the basin 2 can be underground. In embodiment variants, the basin 2 can be closed at the top, for example with a deformable membrane or balloon containing a controlled atmosphere, for example nitrogen.

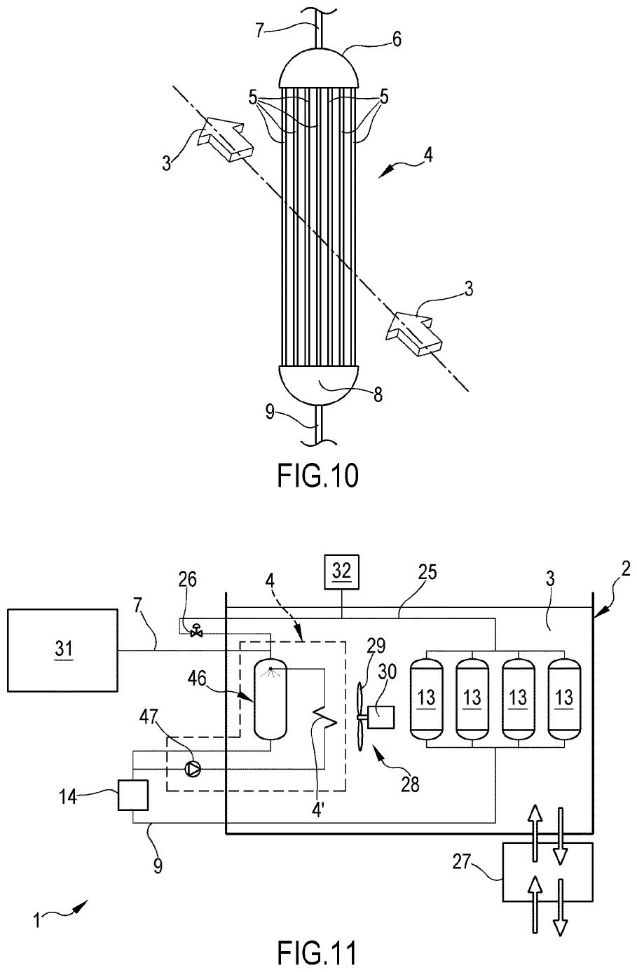

A main heat exchanger 4 is contained in the basin 2 so as to be immersed in the water 3. The main heat exchanger 4, that is shown schematically in FIGS. 1A and 1B, can be, for example but not exclusively thereto, of the bundle of tubes 5 type as shown in FIG. 10. In this example, the main heat exchanger 4 comprises a first collector 6 connected to a first pipeline 7, a second collector 8 connected to a second pipeline 9 and a plurality of tubes 5 parallel to each other and connecting the first collector 6 with the second collector 8. The first pipeline 7 and the second pipeline 9 define main ducts of the apparatus 1. In the shown embodiment, the first collector 6 is placed upwards, the second collector 8 is placed downwards and the tubes 5 are vertical.

The main heat exchanger 4 is fixed to the basin 2 via appropriate anchorages of a type known in itself and not shown in detail herein. The first collector 6, the second collector 8 and the tubes 5 delimit passages inside the main heat exchanger 4, so that a first end of these passages is in fluid communication with the first pipeline 7 and a second end of these passages is in fluid communication with the second pipeline 9.

As it can be noted, an internal volume of the internal passages of the main heat exchanger 4 is much lower than the volume of the basin 2, i.e. of the water 3.

Preferably, a ratio of volume of the basin 2 to the internal volume of the main heat exchanger 4 is greater than one hundred. For example, the internal volume of the internal passages is equal to about 1.25 m³ or 1250 liters, so that the ratio of the volume of the basin 2 to the internal volume of the main heat exchanger 4 is equal to two hundred. In other variants, said ratio can be greater than three hundred, optionally greater than five hundred.

The apparatus 1 comprises furthermore a liquid-vapour separator 10 placed in the basin 2 and immersed in the water 3. The liquid-vapour separator 10 can show a structure of known type that therefore is not herein described in detail. The liquid-vapour separator 10 is placed on the first pipeline 7 and is then, on one side, in fluid communication with the first end of the passages of the main heat exchanger 4. For example, the liquid-vapour separator 10 is placed at a height equal to about the one of the first collector 6. The liquid-vapour separator 10 is fixed to the basin 2 via appropriate anchorages of a type known in itself and not shown in detail herein. In embodiment variants, the liquid-vapour separator 10 can also be placed outside of the basin 2, i.e. may also be not immersed in the water 3.

A main reservoir 11 is placed in the basin 2 and is immersed in the water 3. The main reservoir 11 can have a structure of known type that is therefore not described herein in detail. The main reservoir 11 is placed on the second pipeline 9 and is then, on one side, in fluid communication with the second end of the passages of the main heat exchanger 4. The main reservoir 11 is placed under the liquid-vapour separator 10 and is, for example, placed at a height equal about to the one of the second collector 8. A respective pipeline 12 connects the liquid-vapour separator 10 to the main reservoir 11. The main reservoir 11 is fixed to the basin 2 via appropriate anchorages of a type known in itself and not shown in detail herein. This respective pipeline 12 is shown immersed too in the water 3 in the attached figures but can also be outside of the basin 2.

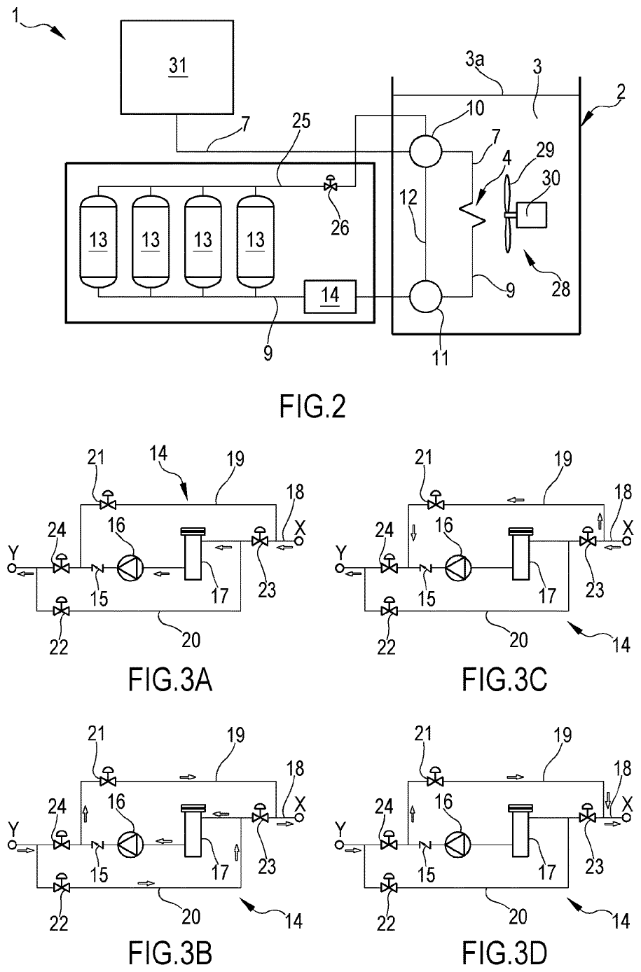

The apparatus 1 comprises furthermore a plurality of storage reservoirs 13 that, in the embodiment of FIGS. 1A and 1B, are placed too in the basin 2 and immersed in the water 3. In the variant of FIG. 2, these storage reservoirs 13 are outside of the basin 2. The storage reservoirs 13 are connected to a terminal end of the second pipeline 9. In FIGS. 1A and 1B these storage reservoirs 13 are vertical cylinders placed next to each other and are connected to the second pipeline 9 in parallel. In embodiment variants, the storage reservoirs 13 can be connected together in series or in series and in parallel. A control valve or a plurality of control valves, each one associated to one of the reservoirs 13, not shown, can be arranged on the second pipeline 9. Also the storage reservoirs 13 are fixed to the basin 2 via appropriate anchorages of a type known in itself and not shown in detail herein. Possibly, the storage reservoirs 13 can furthermore be insulated to limit the heat exchanges with the external environment (atmosphere if outside of the basin 2 or water if positioned in the basin 2).

On the second pipeline 9, between the main reservoir 11 and the plurality of storage reservoirs 13, is operatively positioned a pumping station 14. An example of the structure of the pumping station 14 is shown in figures from 3A to 3D. In this example, the pumping station 14 comprises a non-return valve 15, a pump 16 and a filter 17 placed in series on a first line 18, wherein the non-return valve 15 is located between the pump 16 and the storage reservoirs 13 whereas the filter 17 is placed between the pump 16 and the main reservoir 11. The non-return valve 15 is placed on the delivery of the pump 16. The pumping station 14 comprises a second line 19 that bypasses the non-return valve 15, the pump 16 and the filter 17 and a third line 20 that bypasses the non-return valve 15, the pump 16 and the filter 17.

The second line 19 is provided with a respective actuated valve 21. The third line 20 is provided with a respective actuated valve 22. An actuated valve 23 is furthermore placed on the first line 18, between the filter 17 and the main reservoir 11 and between the branches of the second line 19 and of the third line 20. An actuated valve 24 is furthermore placed on the first line 18, between the non-return valve 15 and the storage reservoirs 13 and between the branches of the second line 19 and of the third line 20.

A steam balancing pipeline 25, provided with a respective adjustment valve 26, connects upper portions of the storage reservoirs 13 with the first pipeline 7. The adjustment valves can also be more than one, for example one for each one of the reservoirs 13. In FIGS. 1A and 1B, this steam balancing pipeline 25 is connected to a point of the first pipeline 7 comprised between the main heat exchanger 4 and the liquid-vapour separator 10. In embodiment variants, the steam balancing pipeline 25 can be connected to the first end of the main heat exchanger 4 or to the liquid-vapour separator 10, as in FIG. 2.

In the not limiting example of FIGS. 1A and 1B is furthermore present an auxiliary system 27, which is operatively coupled to the basin 2 and is configured to exchange heat with water 3 in the basin 2 and with the external environment in a controlled manner. This auxiliary system 27 can comprise a chiller (chiller) able to remove heat from the water 3 and release it to the external environment or a heater able to release heat, absorbed from the external environment, to the water 3. The auxiliary system 27 can comprise an its own circuit defined by respective ducts immersed in the water 3 of the basin 2 or the water of the basin 3 is circulated outside of the basin 2 and brought in the auxiliary system 27.

The apparatus 1 of the embodiment of FIGS. 1A and 1B comprises furthermore a circulation device 28 defined by a propeller 29 moved in rotation by an electric motor 30. The circulation device 28 is contained in the basin 2 and immersed in the water 3 and is configured to generate within the basin 2 at least a closed circulation path of the water 3 so as to move the water 3 in said basin 2 and with respect to the main heat exchanger 4 (forced circulation). The basin 2 shown in FIGS. 1A, 1B and 2 delimits a closed volume and the circulation device 28 circulates always the same water 3 in the closed volume. In this way, the water 3 laps the tubes 5 of the heat exchanger 4 and passes through passages delimited between adjacent tubes 5. In the embodiment of FIGS. 1A, 1B and 10, the flow of the water 3 in the basin 2 is orthogonal with respect to the above-mentioned tubes 5.

In embodiment variants, the circulation device 28 can be any means to overcome the small pressure drops that occur in the basin 2, because of the interaction of the working fluid in movement with the walls of the basin 2 and/or of the passage of the working fluid in movement between the tubes 5 of the main heat exchanger 4. For example, the circulation device 28 can be a pump (for example, axial pumps or lifting pumps). In embodiment variants, the circulation device 28 can also be placed outside of the basin 2 and placed in fluid communication with the basin 2 via a respective pipe.

The first pipeline 7 is connected to a first source 31 of a working fluid in the gaseous state. For example, this first source 31 is a container that contains the working fluid and this working fluid is, for example, carbon dioxide (CO₂) in the gaseous state. In embodiment variants, the working fluid can be air that is used together with the cryogenic propane as thermal mass.

The apparatus 1 shown comprises a device 32 configured to eliminate non-condensable gases placed at an upper portion of the apparatus 1, where there is the gaseous phase of the working fluid. In the exemplary embodiment of FIGS. 1A and 1B, this device 32 for eliminating non-condensable gases is connected to the steam balancing pipeline 25. In embodiment variants, this device 32 for eliminating non-condensable gases can be connected to the first end of the main heat exchanger 4 or to the liquid-vapour separator 10.

The apparatus 1 comprises furthermore an electronic control unit, not shown, operatively connected to the motor 30 to the pumping station 14 and eventually also to other devices (valves, pumps, filters, etc.) for configuring the apparatus 1 in a condensing operating configuration or in an evaporating operating configuration.

A boiling temperature T1 of the water is greater than a condensing/evaporating temperature T2 of carbon dioxide, in particular greater than the critical temperature of the carbon dioxide, so that the carbon dioxide exchanges latent heat while the water exchanges sensitive heat, i.e. varies its own temperature.

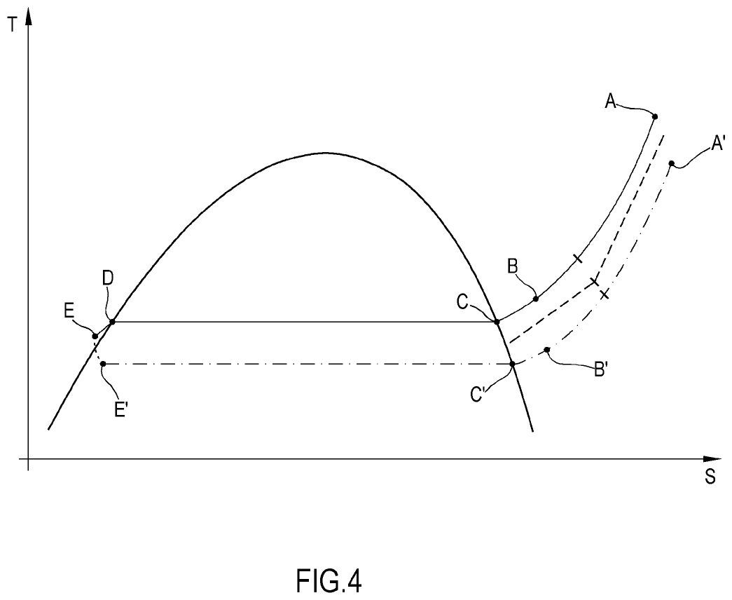

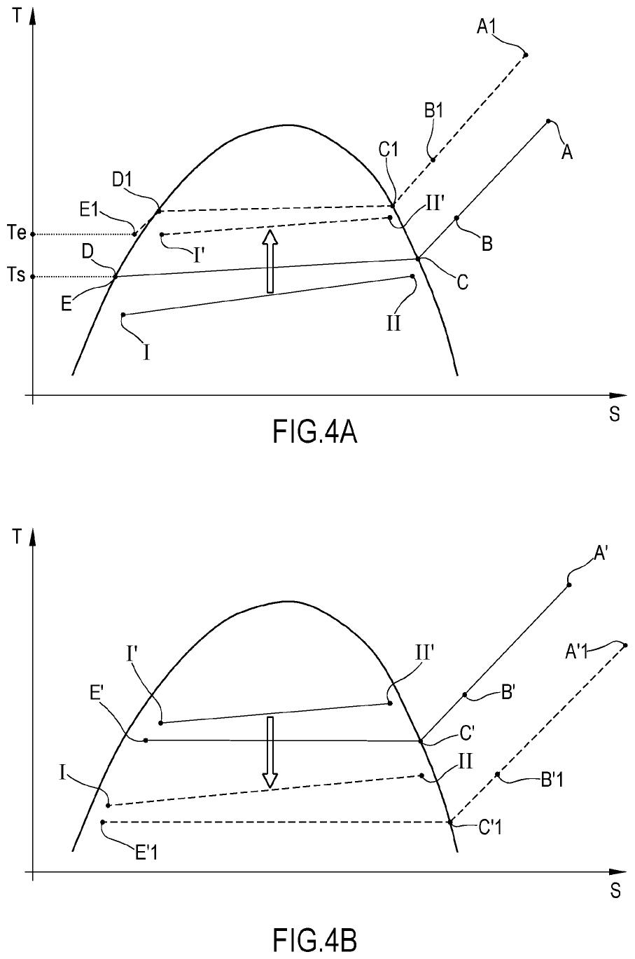

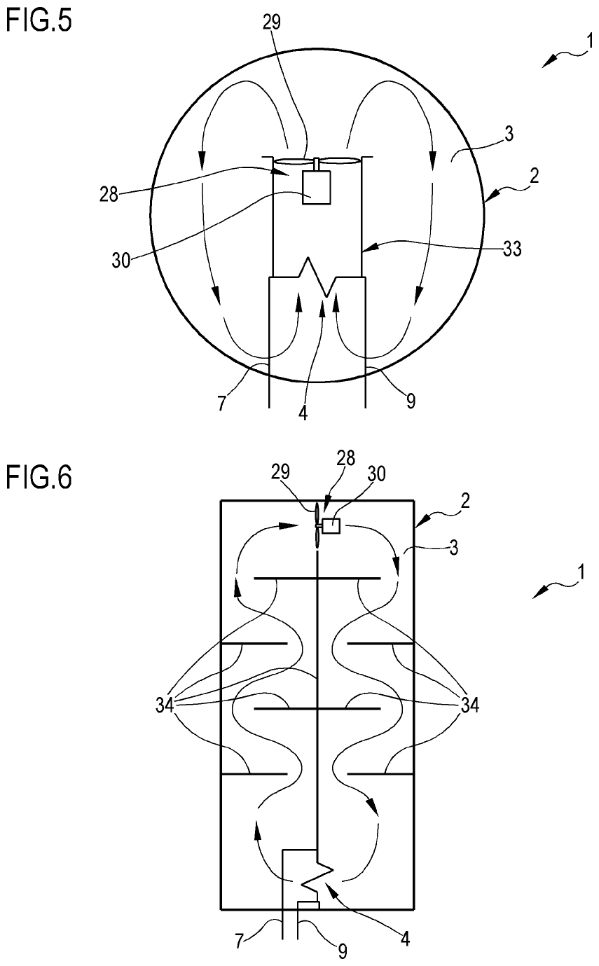

In the condensing operating configuration, the carbon dioxide in the gaseous state flows from the first source 31 through the main heat exchanger 4, releases heat to the water 3 (that heats up) and condenses inside the tubes 5 to be then accumulate in the liquid state in the storage reservoirs 13 (FIG. 1A). This process is shown in the T-S diagram of FIG. 4 and in the following table 1.

TABLE 1

| | |
|---|---|
| B-C | The gas is first de-superheated |
| C-D | The gas is condensed |
| D-E | The gas is sub-cooled (optional) |

In the evaporating operating configuration, the liquid carbon dioxide flows from the storage reservoirs 13 through the main heat exchanger 4, where it absorbs heat from the water 3 (that cools down) and evaporates inside the tubes 5 to be then entered again in the container in the gaseous state (FIG. 1B). This process is shown in the T-S diagram of FIG. 4 and in the following table 2. In this configuration, the main reservoir 11 and the storage reservoirs 13 carries out the function of a second source of the working fluid in the liquid state.

TABLE 2

| | |
|---|---|
| E-E′ | The gas is brought from the condensing |
| | pressure (or from the balance pressure |
| | with the thermal mass) to the evaporating |
| | pressure |
| E′-C′ | The gas is evaporated |
| C′-B′ | The gas is superheated |

The water 3 is then a thermal mass that exchanges heat with the carbon dioxide placed within the main heat exchanger 4 and furthermore the water 3, in the evaporating configuration, stores the heat and retains it to then, in the evaporating configuration, release it again to the carbon dioxide.

In the condensing operating configuration, the pumping unit 14 is configured to move the just condensed working fluid and in the liquid state from the main reservoir 4 toward the storage reservoirs 13, i.e. from the point X to the point Y in FIGS. 3A and 3C. In the evaporating operating configuration, the pumping unit 14 is configured to move the working fluid in the liquid state from the storage reservoirs 13 toward the main reservoir 4, i.e. from the point Y to the point X in FIGS. 3B and 3D. The pumping unit 14 is able to move the fluid from the point X to the point Y or vice versa using a pressure difference favorable to the flow or through the pump 16 or also by gravity. For example, the four cases shown in the following table 3 are identified.

TABLE 3

| | Case 1 | Case 2 | Case 3 | Case 4 |
|---|---|---|---|---|
| Flow direction | from X to Y | from Y to X | from X to Y | from Y to X |
| Pressure | PX < PY | PX > PY | PX > PY | PX < PY |
| condition | | | | |
| Pump 16 | On | On | Off | Off |
| Valve 23 | Open | Closed | Closed | Closed |
| Valve 21 | Closed | Open | Open | Open |
| Valve 24 | Open | Closed | Open | Open |
| Valve 22 | Closed | Open | Closed | Closed |

The valves of the pumping unit 14 can laminate the working fluid from a greater pressure to a lower pressure and, if the upward state of the respective valve is “saturated” liquid, downwards the valve is possible to have a mixture of liquid with vapour, this is to perform the passage from the point E to the point E′ shown in the T-S diagram of FIG. 4.

The liquid-vapour separator 10 separates a liquid phase of the carbon dioxide in the gaseous state that enters in or comes out of the main heat exchanger 4. The separated liquid phase in the above liquid-vapour separator 10 falls by gravity into the main reservoir 11 below through the respective pipeline 12 that, for example, has a geometry such as to define a hydraulic guard, i.e. to ensure that all the carbon dioxide in vapour phase passes through the main heat exchanger 4, i.e. preventing that the vapour bypasses this main heat exchanger 4.

FIGS. 4A and 4B show with more precision what is above described with reference to FIG. 4. FIG. 4A represents the condensing operating configuration and the FIG. 4B represents the evaporating operating configuration.

In the condensing operating configuration (FIG. 4A), the water 3 continues to recirculate while the carbon dioxide condenses. Therefore, the line I-II, that represents the water that heats up, is not fixed but gradually moves upwards, up to I′-II′. Then, also the condensating line C-D of the carbon dioxide gradually moves upwards, up to C1-D1 and, at the end of condensation, the condensed carbon dioxide is in D1 (in E1 with the possible sub-cooling). Then, a temperature Ts of the carbon dioxide at the beginning of condensation, when is all in vapour phase, is lower than a temperature Te of the carbon dioxide at the end of condensation, when it is in liquid phase.

In the evaporating operating configuration (FIG. 4B), the water 3 continues to recirculate while the carbon dioxide evaporates. Therefore, the line I′-II″, that represents the water that cools down, is not fixed but gradually moves downwards, until I-II, and also the evaporating line E′-C′ of the carbon dioxide gradually moves downwards, until E′1-C′1.

In embodiment variants, not shown, the heat exchanger is as the one shown in FIG. 10 and above described and is of the “once-through” type, i.e. all the working fluid entering from one side exits from the other and there are no accumulations. In these variants, the pipeline 12 is not present or a valve is arranged on that pipeline 12. The use of the “once-through” exchanger allows to condense and evaporate working fluids constituted by gas mixtures (for example air or CO2 not pure at 100%) without the individual components separating and allows to ensure that the concentration of these components during the discharge in the condensate that has to evaporate does not change. Otherwise, if a first component evaporates before a second component, it would evaporate first a mixture with less concentration of the second component, enriching the remaining mixture with said second component. For example, if the working fluid was air (78% Nitrogen, 20% Oxygen, 2% other) and no “once-through” type heat exchanger was used, it would evaporate first a mixture with little oxygen with the consequence of having a very oxygen-rich mixture in the final step.

The steam balancing pipeline 25 and the adjustment valve 26 are configured to “balance” the vapour phase of the carbon dioxide contained in the storage reservoir 13 with the first end of the main heat exchanger 11 whereas the device 32 configured to eliminate non-condensable gases allows to eliminate these non-condensable gases from points of possible accumulation.

Along the closed circulation path, the flow of the water 3 passes through a first transit section of the water (orthogonal to a flow direction) that depends on the dimensions of the basin 2, its geometry, number and characteristics of the circulation device 28. The first transit section is for example equal to 50 m². Inside the tubes 5 of the main heat exchanger 4, the working fluid passes through a second transit section of the working fluid that is the sum of the sections of the tubes 5. The second transit section is for example of 5 m². Then, a ratio of the first transit section to the second transit section is equal to ten. Furthermore, a transit velocity of the water through the first transit section is low, for example lower than 1 m/s, for example equal to about 0.05 m/s. A transit velocity of the liquid through the second transit section is for example equal to about 0.1 m/s.

The apparatus 1 described is able to receive a working fluid in gaseous phase at a temperature close to or greater than its condensing temperature and to make this working fluid available in the liquid phase, having removed the latent heat extracted from the working fluid during the phase change. The system is able to perform also the reverse operation, i.e. take the working fluid in liquid phase, supply heat to it to make it evaporate (taking such heat from the water 3) and eventually superheat it with the sensitive heat set aside in the first step.

FIG. 5 shows from above a different possible geometry of the basin 2, which in this case has a circular shape and comprises furthermore a conveyor 33 immersed in the water 3. In the shown example, the conveyor 33 is defined by a cylindrical body with open opposite ends and communicating with the internal volume of the basin 2. A main axis of the cylindrical body is horizontal. The main heat exchanger 4 is placed near a first open end of the cylindrical body whereas the propeller 29 of the circulation device 28 is positioned near a second open end of the cylindrical body. As shown, this geometry produces two water flows circulating according to two closed circulation paths in the basin 2 (one flow circulates clockwise and the other one counterclockwise) and the cylindrical body addresses the water 3 of both closed circulation paths towards the main heat exchanger 4. In not shown embodiment variants, the main heat exchanger 4 and/or the propeller 29 can be placed in the cylindrical body. In not shown embodiment variants, the conveyor 33 can also take on different shapes, for example the hood shape.

FIG. 6 shows from above another variant in which the basin 2 has a rectangular perimeter and is provided with a plurality of flow diverters 34 immersed in the water 3 of the basin 2 and defined by walls that delimit a unique closed circulation path with a serpentine trajectory. Specifically, the flow diverters 34 comprise a central wall that subdivides substantially in two the basin 2, a plurality of walls that protrude from the central wall and a plurality of walls that protrude from the lateral walls of the basin 2. The propeller 29 of the circulation device 28 is positioned in an opening delimited between a first end of the above-mentioned central wall and one of the lateral walls of the basin 2. The main heat exchanger 4 is placed in an opening delimited between a second end of the above-mentioned central wall and one of the lateral walls of the basin 2.

FIG. 7 shows a variant of the apparatus 1 that comprises furthermore an auxiliary device 35 placed between the liquid-vapour separator 10 and the first source 31. The auxiliary device 35 comprises a first auxiliary heat exchanger 36A and a second auxiliary heat exchanger 36B placed in series on the first pipeline 7. The first auxiliary heat exchanger 36A and the second auxiliary heat exchanger 36B have therefore passages in fluid communication with the first pipeline 7 which are crossed by the working fluid (carbon dioxide). The first auxiliary heat exchanger 36A and the second auxiliary heat exchanger 36B have furthermore passages connected to the basin 2 which are crossed by the water 3 of the basin 2. For this purpose, with reference to FIG. 7, an auxiliary pipeline 37 extends from the basin 2 up to the first auxiliary heat exchanger 36A and to the second auxiliary heat exchanger 36B. Downwards the first auxiliary heat exchanger 36A, a branch of the auxiliary pipeline 37 is connected to a first auxiliary reservoir 38A. Downwards the second auxiliary heat exchanger 36B, the auxiliary pipeline 37 is connected to a second auxiliary reservoir 38B. An auxiliary pump 39 with a respective bypass duct 40 provided with a respective valve 41 is placed on the auxiliary pipeline 37 between the basin 2 and the first auxiliary heat exchanger 36A. A first auxiliary pump 39A with a respective bypass duct 40A provided with a respective valve 41A is placed on the branch. A second auxiliary pump 39B with a respective bypass duct 40B provided with a respective valve 41B is placed between the second auxiliary heat exchanger 36B and the second auxiliary reservoir 38B.

The first auxiliary reservoir 38A and the second auxiliary reservoir 38B are used to store the water 3 at different and upper temperatures with respect to the water 3 in the basin 2.

The first and the second auxiliary heat exchanger 36A, 36B result placed upwards separator 10 and of the main heat exchanger 4 when the apparatus 1 is in the condensing operating configuration, for de-superheating the working fluid, i.e. for bringing the temperature of the working fluid next to the condensing temperature (B in FIG. 4) starting from an upper inlet temperature (A).

The first and the second auxiliary heat exchanger 36A, 36B result placed downwards the main heat exchanger 4 when the apparatus 1 is in the evaporating configuration, for superheating the working fluid, i.e. for bringing the temperature of the working fluid next to the inlet temperature of the fluid in the system (A′) starting from a temperature equal or close to the evaporating temperature (B′ or C′).

FIG. 7 shows the first auxiliary reservoir 38A and the second auxiliary reservoir 38B placed outside of the basin 2. In a not shown embodiment variant, the first auxiliary reservoir 38A and the second auxiliary reservoir 38B are arranged in the basin 2 and immersed in the water 3 or obtained in compartments obtained in the basin 2. The first auxiliary reservoir 38A and the second auxiliary reservoir 38B can furthermore be insulated for limiting the thermal exchange with the surrounding environment (that can be the external environment or the basin 2 if they are immersed in the water 3 of the basin 2)

In another non-shown variant, the auxiliary device 35 does not work with the water 3 of the basin 2 but with a thermal vector different from water 3 of the basin 2. In this case, the auxiliary pipeline 37, instead of the basin 2, is connected to one or more auxiliary reservoirs in which the thermal vector is stored at low temperature.

FIG. 8 shows a variant of the apparatus 1 that shows an alternative to the auxiliary system 27 of FIGS. 1A and 1B configured to exchange heat with the water 3 in the basin 2 and with the external environment in a controlled manner. In this embodiment, the auxiliary system 27 is connected to the first pipeline 7 and to the second pipeline 9 and is arranged in parallel with respect to the main heat exchanger 4. The auxiliary system 27 of this embodiment is configured to exchange heat with the water 3 in the basin 2 via the working fluid (carbon dioxide) that passes in the main heat exchanger 4. The auxiliary system 27 comprises: an auxiliary compressor 42, an auxiliary expander 43 (or in alternative a lamination valve), an additional heat exchanger 44 interposed between the auxiliary compressor 42 and the auxiliary expander 43, an auxiliary motor 45 mechanically connected to the auxiliary compressor 42 and/or to the auxiliary expander 43. The auxiliary compressor 42 is in fluid connection with the first pipeline 7, the auxiliary expander 43 is in fluid connection with the second pipeline 9. The auxiliary compressor 42 and the auxiliary expander 43 are in fluid connection with each other and the additional heat exchanger 44 is operatively placed on the connection between the auxiliary compressor 42 and the auxiliary expander 43. The auxiliary compressor 42, the additional heat exchanger 44, the auxiliary expander 43 and the main heat exchanger 4 form a closed circuit. Through the introduction of electrical energy via the auxiliary motor 45, the auxiliary system 27 of FIG. 8 is able to carry out a chiller cycle with the working fluid and to directly remove heat from the working fluid and, consequently, from the water 3 contained in the basin 2. The main heat exchanger 4 acts as evaporator in the chiller cycle here described.

In an embodiment variant not shown in the figures, it is present also a pump and the auxiliary motor 45 is a motor-generator. The auxiliary system 27 realizes a power cycle that produces energy and wherein the main heat exchanger 4 acts as condenser in this cycle.

In variants not shown in the figures but still part of the present invention, the apparatus 1 comprises a first main heat exchanger that acts as condenser in the condensing operating configuration and a second different main heat exchanger that acts as evaporator in the evaporating operating configuration. The first and the second main heat exchanger are placed in parallel with each other. Each of the above-mentioned first and second main heat exchanger has a first end in fluid connection with the liquid-vapour separator 10 and with the first source 31 and a second end in fluid connection with the main reservoir 11 and with the storage reservoirs 13.

Furthermore, both the unique main heat exchanger previously described and each of the mentioned first and second main heat exchanger herein described can be formed by a plurality of exchangers that work in series or in parallel.

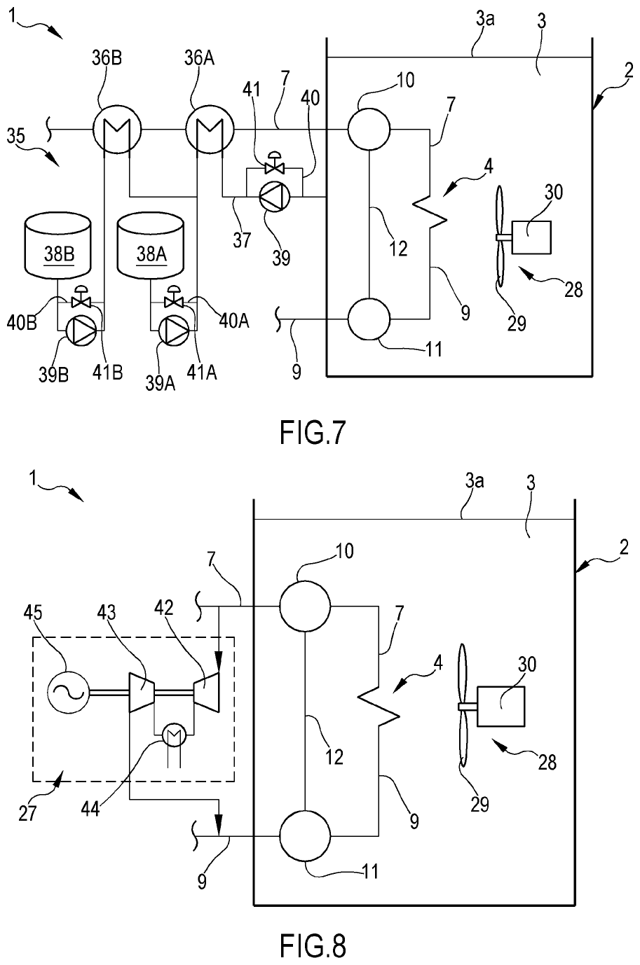

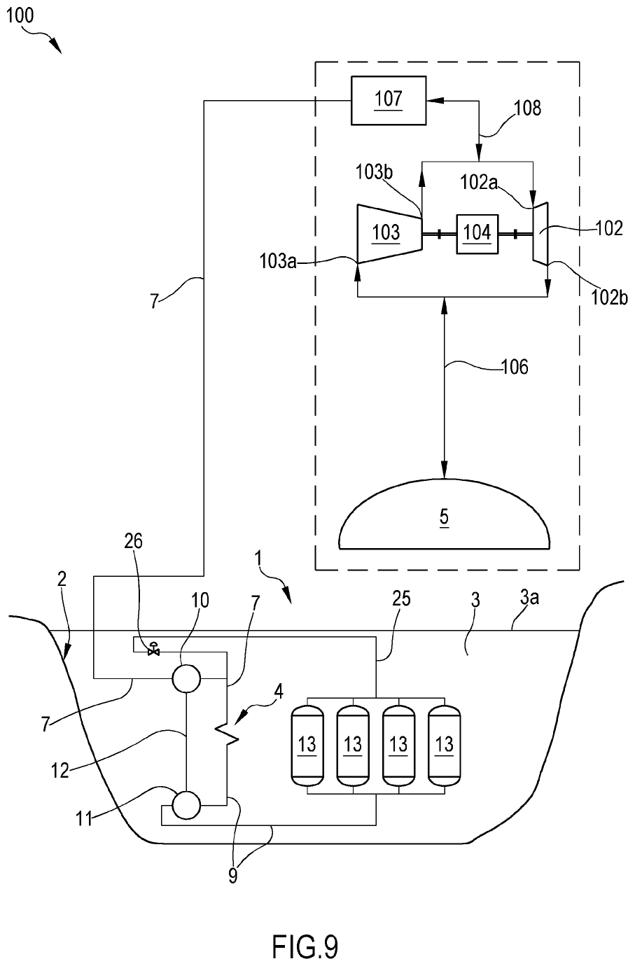

FIG. 9 shows a plant 100 for energy transformation and storage that comprises and uses an apparatus 1 for accumulation of thermal energy according to the present invention. This plant 100 can be similar to one of the embodiments described in the public documents WO2021191786A1 and WO2021255578A1, in the name of the same Applicant. The apparatus 1 according to the present invention is used in the plant 100 as secondary heat exchanger.

More in detail, the plant 100 shown works with a working fluid other than atmospheric air, for example chosen in the group comprising: carbon dioxide CO₂, sulphur hexafluoride SF₆, nitrogen oxide N₂O. The plant 100 is configured to actuate a closed cyclic thermodynamic transformation (TTC), first in one direction in an accumulation configuration/step and then in an opposed direction in a discharge configuration/step, wherein in the accumulation configuration the plant 100 stores heat and pressure and in the discharge configuration generates electrical energy.

With reference to FIG. 9, the plant 100 comprises an expander, for example a turbine 102, and a compressor 103 mechanically connected to a motor-generator shaft 104.

The plant 100 comprises an enclosure 105 defined by a a pressostatic balloon in flexible material, for example in PVC coated polyester fabric. The pressostatic balloon is arranged on the surface and is externally in contact with the atmospheric air. The pressostatic balloon delimits within it a volume configured to contain the working fluid at atmospheric or substantially atmospheric pressure, i.e. in pressure balance with the atmosphere during all the steps of the cycle operated by the plant 100. The enclosure 105 can also be realized as a gasometer or a double membrane pressostatic balloon or any other low or zero overpressure gas storage system, wherein as the volume of the working fluid changes, the pressure is kept constant or substantially constant.

First ducts 106 develop between the enclosure 105 and an inlet 103a of the compressor 103 and between the enclosure 105 and an outlet 102b of the turbine 102 for putting in fluid communication the internal volume of the enclosure 105 with said compressor 103 and turbine 102.

A valve or a valve system, not shown, can be operatively located on the first ducts 106 for putting in fluid communication alternatively the enclosure 105 with the inlet 103a of the compressor 103 or the outlet 102b of the turbine 102 with the enclosure 105.

The plant 100 comprises a primary heat exchanger 107 that can be put selectively in fluid communication with an outlet 103b of the compressor 103 or with an inlet 102a of the turbine 102. For this purpose, second ducts 108 develop between the inlet 102a of the turbine 102 and the primary heat exchanger 107 and between the outlet 103b of the compressor 103 and the primary heat exchanger 107. The primary heat exchanger 107 is or is associated to a thermal accumulator (Thermal Energy Storage-TES).

A valve, or a valve system, not shown, is operatively located on the second ducts 108 for putting in fluid communication alternatively the primary heat exchanger 107 with the inlet 102a of the turbine 102 or the outlet 103b of the compressor 103 with the primary heat exchanger 107.

The apparatus 1 of the above-described type is in fluid communication with the primary heat exchanger 107 and is configured to accumulate the working fluid in the liquid phase at a temperature close to the critical temperature. The critical temperature of the working fluid is close to the environmental temperature and is preferably comprised between 0° C. and 100° C.

In the embodiment shown in FIG. 9, the first pipeline 7 of the apparatus 1 is connected to the primary heat exchanger 107 so as the liquid-vapour separator 10 remains interposed between the main heat exchanger 4 of the apparatus 1 and the primary heat exchanger 107 of the plant 100.

In the accumulation configuration, the working fluid in the gaseous state coming from the enclosure 105 is compressed in the compressor 103 and heats up. The working fluid flows then through the primary heat exchanger 107 that acts as cooler to remove part of the heat from the compressed working fluid, cool it and accumulate the thermal energy removed from said working fluid. The working fluid reaches then the apparatus 1 where it is condensed (in the main heat exchanger 4) and accumulated in the storage reservoirs 13 whereas further thermal energy is accumulated in the water 3 of the basin 2. The working fluid is accumulated in the storage reservoirs 13 in the liquid state with a temperature close to the critical temperature.

In the discharge configuration, the working fluid coming from the reservoirs 13 of the apparatus 1 is vaporized (in the main heat exchanger 4) using the thermal energy previously accumulated in the water 3 of the basin 2 and sent to the primary heat exchanger 107 that now acts as heater and releases further heat, previously accumulated, to the working fluid and heats it up. The working fluid is then entered into the turbine 102 and accumulated again in the gaseous state in the enclosure 105.

As it can be seen from FIG. 9, the apparatus 1 of this embodiment does not comprise an artificial basin but a natural basin, for example, a lake or a river. FIG. 9 represents in section a river bed. The water 3 in the river flows naturally and there is then no circulation device. Furthermore, the enclosure 105, the turbine 102, the compressor 103, the motor-generator 104 and the primary heat exchanger 107 can be mounted on a floating unit that floats on the river (or lake or sea) while the apparatus 1 is immersed in the river itself.

FIG. 11 shows another variant of the apparatus 1 of the invention which differs from the one of FIGS. 1A and 1B since the main heat exchanger 4 comprises a heat exchanger 4′ as the one described above combined with a direct-contact condenser 46 and to a circulation pump 47 arranged on a circulation circuit, wherein the direct-contact condenser 46 and the heat exchanger 4′ are immersed in the water 3 of the basin 2 and the circulation pump 47 is outside of the basin 2.

In the condensing configuration, the carbon dioxide in the gaseous state flows from the first source 31 right into the direct-contact condenser 46 and condenses by effect of the contact with a liquid part that recirculates through the circulation pump 47 and the exchanger 4′ and is sprayed in the direct-contact condenser 46. The liquid part that is accumulated in the direct-contact condenser 46 is then transferred to the storage reservoirs 13 via the pumping unit 14.

In the evaporating operating configuration, the liquid carbon dioxide is pumped via the pumping unit 14 from the storage reservoirs 13 until the circulation pump 47, circulates through the exchanger 4′ and is sprayed in the direct-contact condenser 46. The gaseous part that is accumulated in the direct-contact condenser 46 comes out from above of the direct-contact condenser 46 toward the container of the first source 31.

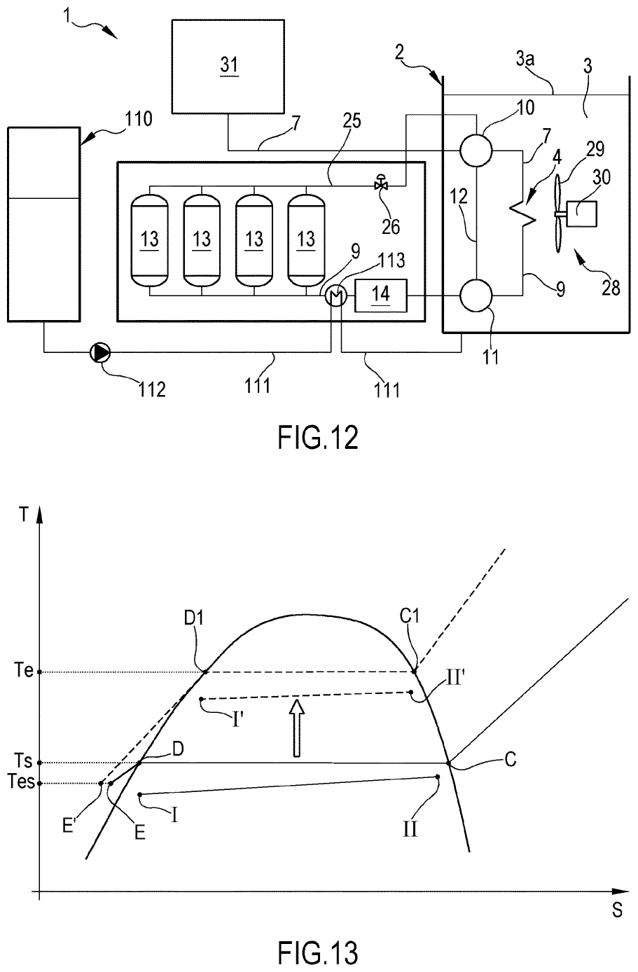

FIG. 12 shows a variant of the apparatus 1 of FIG. 2 and FIG. 13 shows the condensing operating configuration operated by the apparatus of FIG. 12.

The apparatus of FIG. 12 comprises all the elements of the apparatus of FIG. 2.

In addition, an additional basin 110 is connected to the basin 2 via an additional pipeline 111. An additional pump 112 is operative on the additional pipeline 111 and this additional pipeline 111 is operatively coupled to the second pipeline 9 via a further heat exchanger 113 so that the water that flows in the additional pipeline 111 can exchange heat with the carbon dioxide that flows in the second pipeline 9. The further heat exchanger 113 is placed between the pumping station 14 and the storage reservoirs 13. In the additional basin is contained water at a temperature lower than the temperature Ts of the carbon dioxide at the beginning of condensation (see FIG. 4A and the relative description).

The variant of FIG. 12 allows, in the condensing operating configuration (charge step), to sub-cool the carbon dioxide so as to maintain the temperature Te of the carbon dioxide in liquid phase at the end of condensation close to the temperature Ts of the carbon dioxide in vapour phase at the beginning of condensation.

For this purpose, in the condensing operating configuration, the water contained in the additional basin 110 is pumped by the additional pump 112 toward the basin 2 and, while it passes into the further heat exchanger 113, absorbs heat from the carbon dioxide that flows toward the reservoirs 13, by cooling it (sub-cooling).

The volume necessary to store the liquid carbon dioxide in the reservoirs 13 depends on the density difference between the beginning of the charge (all vapour at the charge beginning temperature Ts) and the end of the charge (all liquid at the charge end temperature Te>Ts). The greater the difference between Te and Ts is and the lower the density difference between the liquid and the vapor is. Then, to increase the density difference between liquid and vapour and reduce the volume of reservoirs 13 (and their cost), the difference can be decreased between Te and Ts and, as shown in FIG. 13, the variant of FIG. 12 allows to obtain this result. In fact, the charge end temperature Tes with sub-cooling (i.e. in E1) is close to the charge beginning temperature Ts and the difference Tes−Ts is lower than Te−Ts, where Te is the charge end temperature without sub-cooling (i.e. in D1).

The following table 4 shows the effect of the sub-cooling operated by the apparatus of FIG. 12 on the density of the carbon dioxide and then on the volume of reservoirs 13. The points indicated in table 4 are those of FIG. 13.

TABLE 4

| | P | T | H | Density | Title |
|---|---|---|---|---|---|
| Point | [bar] | [° C.] | [kJ/kg-K] | [kg/m3] | [%] |
| C (Saturated vapour) | 43.0 | 8.16 | 424.7 | 127.1 | 100% |
| D1 (Saturated liquid) | 63.0 | 24.08 | 270.96 | 723.8 | 0% |
| E1 (Sub-cooled liquid) | 63.0 | 8.00 | 217.08 | 899.7 | 0% |
| Density difference D1 − C | | | | 596.74 | |
| Density difference E1 − C | | | | 772.65 | |
| Gain % | | | | 29.5% | |

By adopting the technical solution of FIG. 12 (additional basin 110, additional pipeline 111, additional pump 112 and further heat exchanger 113), it is possible to substantially increase the density of the carbon dioxide in the reservoirs 13 (in the example of about 30%) and then reduce the volume of necessary reservoirs, their dimensions and the relative cost.

In the evaporating operating configuration (discharge step), the carbon dioxide is heated before evaporating it to bring it next to the evaporating temperature by following the inverse path, and then cooling down again part of the water contained in the basin 2.

In the variant of FIG. 12, the reservoirs 13 that contain the carbon dioxide can also be placed inside the additional basin 110.

### Tests

Tests were performed comparing the apparatus according to the invention with a shell & tube type exchanger wherein the above-described working fluid is in internal tubes of the shell & tube while water is flown between the internal tubes and the external shell via a pump placed in pipes that bring it inside the shell.
Heat to remove (duty): 10000 [KWt]
Time/energy to accumulate: 10 [h]/360000 [MJ] (10 [h*3600 [s/h]*10 [MWt])
Thermal mass used: water
Temperature increase of the water for storing the heat 4 [C]

For storing the latent heat in sensitive heat of the water, and considering to heat up the water of 4 [° C.] it is necessary a charge volume 21500 [m³] of water.
Water velocity in the connection pipe with the shell of the shell & tube: comprised between 1.5 m/s and 2 m/s (acceptable max 3 m/s)
Transit section in the basin: 50 [m²]
Efficiency of the pump: 80%
Efficiency of the electric motor: 95%
   I. Shell & Tube.
   II. Shell & Tube with 10 times the flow rate of case I and equal velocity in the connection pipe.
   III. Shell & Tube with 10 times the flow rate of case I and maximum acceptable velocity in the pipe.
   IV. Apparatus of the invention with 10 times the flow rate of case I.

| | | I | II | III | IV |
|---|---|---|---|---|---|
| Duty | [kW] | 10000 | 10000 | 10000 | 10000 |
| DT_water | [° C.] | 4 | 0.4 | 0.4 | 0.4 |
| Flow rate | [kg/s] | 597 | 5972 | 5972 | 5972 |
| Vel_pip | [m/s] | 1.80 | 1.81 | 2.97 | 0.12 |
| Piping size | [mm] | 650 | 2050 | 1600 | |
| Pipe section/ | [m²] | 0.33 | 3.30 | 2.01 | 50.00 |
| transit section | | | | | |
| Pressure drop | [bar] | 0.5 | 0.51 | 1.36 | 0.002 |
| HE loss | [bar] | 0.05 | 0.05 | 0.05 | 0.05 |
| Power of the | [kWe] | 43.2 | 436.4 | 1109.5 | 41.0 |
| pump | | | | | |

As it can be seen with 10 times the flow rate the temperature range (DT) becomes a tenth, but in the shell & tube solution, the connection tubes become enormous, and the required power becomes 10 times (case II), or for reducing the pipes at the acceptable velocity limit, the power required becomes 25 times greater due to the high pressure drop.

In the solution according to the invention, there are no tubes, but a transit section, allowing to almost completely eliminate the pressure drops given by the tubes and to keep the power consumed equal to the first case, but with a temperature range (DT) of a tenth (0.4° C. vs 4.0° C.].

### LIST OF ELEMENTS

1 apparatus for thermal energy storage
2 basin
3 water/thermal mass
3a surface of the water
4, 4′ main heat exchanger
5 tubes
6 first collector
7 first pipeline
8 second collector
9 second pipeline
10 liquid-vapour separator
11 main reservoir
12 respective pipeline
13 storage reservoirs
14 pumping station
15 non-return valve
16 pump
17 filter
18 first line
19 second line
20 third line
21, 22, 23, 24 actuated valves
25 steam balancing pipeline
26 control valve
27 auxiliary system
28 circulation device
29 propeller
30 motor
31 first source
32 device configured to eliminate non-condensable gases
33 conveyor
34 flow diverters
35 auxiliary device
36A first auxiliary heat exchanger
36B second auxiliary heat exchanger
37 auxiliary pipeline
38A first auxiliary reservoir
38b second auxiliary reservoir
39 auxiliary pump
39A first auxiliary pump
39B second auxiliary pump
40 bypass duct
40A first bypass duct
40B second bypass duct
41, 41A, 41B valves
42 auxiliary compressor
43 auxiliary expander
44 additional heat exchanger
45 auxiliary motor
46 direct-contact condenser
47 circulation pump
100 plant
102 expander/turbine
102a inlet of the turbine
102b outlet of the turbine
103 compressor
103a inlet of the compressor
103b outlet of the compressor
104 motor-generator
105 enclosure
106 first ducts
107 primary heat exchanger
108 second ducts
110 additional basin
111 additional pipeline
112 additional pump
113 further heat exchanger

1. An apparatus for thermal energy storage, comprising:
a thermal mass comprising a liquid, optionally water, wherein the thermal mass is configured to absorb and store heat or to release heat;
a basin containing the thermal mass;
at least one main heat exchanger contained in the basin and immersed in the thermal mass; wherein the liquid is movable in the basin and with respect to said at least one main heat exchanger;
main ducts connecting said at least one main heat exchanger with a first source of a working fluid in the gaseous state or with a second source of the same working fluid in the liquid state;
wherein a boiling temperature of the liquid of the thermal mass is greater than a condensing/evaporating temperature of the working fluid;
devices for configuring the apparatus in a condensing operating configuration, in which the working fluid in the gaseous state flows from the first source through said at least one main heat exchanger, releases heat to the thermal mass and condenses while the thermal mass heats up, or in an evaporating operating configuration, in which the working fluid in the liquid state flows from the second source through said at least one main heat exchanger, absorbs heat from the thermal mass and evaporates while the thermal mass cools down;
wherein a ratio of a volume of the basin to an internal volume of said at least one main heat exchanger is greater than one hundred, optionally greater than three hundred.

2. The apparatus according to claim 1, wherein a ratio of a first liquid transit section in the basin to a second working fluid transit section in said at least one main heat exchanger is greater than one hundred.

3. The apparatus according to claim 1, wherein the volume of the basin is greater than 1000 m³, optionally greater than 10000 m³; wherein the first transit section is greater than 10 m², optionally greater than 100 m²; wherein a transit velocity of the liquid through the first transit section is lower than 10 m/s, optionally lower than 1 m/s.

4. The apparatus according to claim 1, furthermore comprising at least one reservoir, optionally a plurality of reservoirs, in fluid connection with said at least one main heat exchanger and configured to receive and accumulate the condensed working fluid coming from said at least one main heat exchanger, optionally said at least one reservoir being placed inside the basin and being at least partially immersed in the liquid of the basin.

5. The apparatus according to claim 1, further comprising at least one liquid-vapour separator coupled to said at least one main heat exchanger, optionally said at least one liquid-vapour separator being placed inside the basin and being at least partially immersed in the liquid of the basin.

6. The apparatus according to claim 5, wherein the liquid-vapour separator is placed in the basin in a position above at least one reservoir and is connected to said at least one reservoir via a respective pipeline.

7. The apparatus according to claim 1, wherein the basin is natural or wherein the basin is artificial; wherein the liquid is movable in the basin naturally or by forced circulation.

8. The apparatus according to claim 1, further comprising at least one circulation device operatively active on the liquid and configured to move said liquid in the basin and with respect to said at least one main heat exchanger; optionally wherein said at least one circulation device comprises a propeller or a pump.

9. The apparatus according to claim 8, wherein said at least one circulation device is placed in the basin and immersed in the liquid of the basin.

10. The apparatus according to any claim 8, wherein the basin delimits a closed volume such that said at least one circulation device is configured to generate within the closed volume at least one closed liquid circulation path, wherein the first transit section is a section of said at least one closed circulation path.

11. The apparatus according to claim 1, further comprising at least one conveyor and/or at least one flow diverter housed in the basin and immersed in the liquid of the basin.

12. The apparatus according to claim 1, wherein said at least one main heat exchanger comprises at least one bundle of tubes, wherein the liquid passes between the tubes and laps said tubes and the working fluid passes in said tubes; optionally wherein a flow of the liquid in the basin is orthogonal with respect to said tubes.

13. The apparatus according to claim 1, comprising an auxiliary device comprising at least one auxiliary heat exchanger; said at least one auxiliary heat exchanger being placed upstream of said at least one main heat exchanger when the apparatus is in the condensing configuration, for de-superheating the working fluid; said at least one auxiliary heat exchanger being placed downstream of said at least one main heat exchanger when the apparatus is in the evaporating configuration, for superheating the working fluid.

14. The apparatus according to claim 13, wherein said at least one auxiliary heat exchanger is in fluid communication with the basin so as to use the thermal mass or the liquid of the basin to de-superheat or to superheat the working fluid.

15. The apparatus according to claim 14, wherein the auxiliary device comprises at least one auxiliary reservoir in fluid communication with said at least one auxiliary heat exchanger and with the basin, optionally said at least one auxiliary reservoir being placed in the basin and being at least partially immersed in the liquid of the basin.

16. The apparatus according to claim 1, comprising an auxiliary system operatively coupled to the basin and configured to exchange heat with the thermal mass in the basin, optionally the auxiliary system comprising a chiller or a heater.

17. The apparatus according to claim 16, wherein the auxiliary system is in fluid connection with the main ducts and is configured to exchange heat with the thermal mass in the basin via the working fluid, optionally the auxiliary system comprising: a compressor, an expander or a lamination valve, an additional heat exchanger interposed between the compressor and the expander or lamination valve, a motor-generator mechanically connected to the compressor and/or to the expander.

18. The apparatus according to claim 4, comprising a pumping station placed between said at least one main heat exchanger and said at least one reservoir; wherein optionally the plurality of reservoirs comprises a main reservoir directly connected to said at least one main heat exchanger and at least one storage reservoir connected to the main reservoir, wherein the pumping station is placed between the main reservoir and said at least one storage reservoir.

19. The apparatus according to claim 18, wherein a respective pipeline connects a liquid-vapour separator to the main reservoir.

20. The apparatus according to claim 18, comprising: at least one steam balancing pipeline connecting an upper portion of said at least one storage reservoir with a point of the main ducts located between the first source and said at least one main heat exchanger; an adjustment valve operatively active on said at least one steam balancing pipeline.

21. The apparatus according to claim 18, comprising: an additional basin containing the thermal mass and connected to the basin via an additional pipeline; a further heat exchanger operatively active between the additional pipeline and the second pipeline in an area comprised between said at least one storage reservoir and the main heat exchanger, optionally between said at least one storage reservoir and the pumping station, for exchanging heat between the thermal mass and the working fluid; the further heat exchanger, in the condensing operating configuration, being configured to sub-cooling the working fluid before the accumulation in said at least one storage reservoir until keeping a temperature of the working fluid in liquid phase at the end of condensation close to a temperature of the working fluid in vapour phase at the beginning of condensation.

22. A plant for energy transformation and storage, comprising:
a working fluid other than atmospheric air;
an enclosure configured to store the working fluid in gaseous phase;
at least one compressor in fluid communication with the enclosure;
at least one expander in fluid communication with the enclosure;
an apparatus according to at least one of the preceding claims, wherein the main ducts of the apparatus are in fluid communication with said at least one compressor and with said at least one expander;
wherein the plant is configured to actuate a closed cyclic thermodynamic transformation, first in one direction in an accumulation configuration and then in an opposite direction in a discharge configuration; wherein in the accumulation configuration the plant accumulates heat and pressure and in the discharge configuration generates energy.

23. The plant according to claim 22, comprising: a floating unit carrying at least the enclosure, said at least one compressor and said at least one expander; wherein the basin of the apparatus is a river, a lake or a sea and said at least one reservoir and said at least one main heat exchanger are immersed in the river, lake or sea.
